(19) United States
(12) Patent Application Publication
(10) Pub. No.: US 2023/0229523 A1
(43) Pub. Date: Jul. 20, 2023

(54) MANAGING MIGRATION CANCELATION USING MULTIPLE NETWORK INTERFACES

(71) Applicant: VMWARE, INC., Palo Alto, CA (US)

(72) Inventors: Tomo Vladimirov Simeonov, Sofia (BG); Ivaylo Radoslavov Radev, Sofia (BG); Ivailo Vladimrov Loboshki, Sofia (BG); Narasimha Gopal Gorthi, Bangalore (IN); Chandrika Mutalik, Bangalore (IN)

(21) Appl. No.: 17/707,998

(22) Filed: Mar. 30, 2022

(30) Foreign Application Priority Data
Jan. 20, 2022 (IN) 202241003375

(51) Int. Cl. G06F 9/50

(52) U.S. Cl. CPC G06F 9/5077; G06F 9/5088; G06F 9/5038; G06F 9/5055

(57) ABSTRACT

Described herein are systems, methods, and software to manage the migration of workloads from a first computing system to a second computing system. In one implementation, the first computing system identifies a request to migrate one or more workloads to a second computing system. In response to the request, the first computing system disables one or more services and disables all but one network interface on the first computing system. The first computing system then communicates configuration information to the second computing system and monitors for a cancel notification from the second computing system using the remining network interface. After receiving the cancel notification, the first computing system enables the other network interfaces may initiate the one or more services.

### RELATED APPLICATION

Benefit is claimed under 35 U.S.C. 119(a)-(d) to Foreign Application Serial No. 202241003375 filed in India entitled “MANAGING MIGRATION CANCELATION USING MULTIPLE NETWORK INTERFACES”, on Jan. 20, 2022, by VMware, Inc., which is herein incorporated in its entirety by reference for all purposes.

### TECHNICAL BACKGROUND

Computing environments can employ virtual machines, containers, and other virtualized endpoints to use the physical resources of host computing systems more efficiently. The virtualized endpoints are provided with abstracted hardware, including processing systems, memory, storage, and network interfaces that permit each of the virtualized endpoints to communicate with other virtualized endpoints, physical computing systems, or other resources. For example, a first virtual machine may be allocated at least one virtual network interface to communicate with one or more other virtual machines within the computing environment.

During the deployment of a virtual machine, an administrator may desire that an upgrade is provided to the virtual machine. The upgrade may be used to provide increased performance, reliability, or some other update to the virtual machine. However, while the update may provide better performance or reliability, difficulties can arise in managing the downtime of the virtual machine during the update. Additionally, difficulties can arise when a failure occurs for an update. For example, an update may initiate a second updated virtual machine to replace the first virtual machine, wherein the first virtual machine may be required to be turned off prior to the initiation of the second virtual machine. If a failure occurs in initiating the second virtual machine, it can be inefficient to restart the first virtual machine to provide a platform for the desired one or more workloads. Similar issues can be encountered by containers or other virtualized endpoints.

### SUMMARY

The technology described herein manages the migration of workloads from a first virtual machine to a second virtual machine. In one implementation, a first virtual machine identifies a request to migrate one or more workloads from the first virtual machine to a second virtual machine. In response to the request, the first virtual machine identifies configuration for the first virtual machine, wherein the configuration information identifies a first network interface and one or more additional network interfaces, and further disables one or more services and the one or more additional network interfaces of the first virtual machine. After disabling the one or more additional network interfaces, the first virtual machine may communicate at least a portion of the configuration information to the second virtual machine and monitor for a cancel notification from the second virtual machine. Once a cancel notification is received from the second virtual machine, the first virtual machine enables the one or more additional network interfaces and may further initiate the one or more services on the first virtual machine.

### BRIEF DESCRIPTION OF THE DRAWINGS

FIG. 1 illustrates a computing environment to migrate from a first virtual machine to a second virtual machine according to an implementation.

FIG. 2 illustrates an operation of a virtual machine to manage a migration of workloads to a second virtual machine according to an implementation.

FIG. 3 illustrates a timing diagram of providing an update by migrating workloads from a first virtual machine to a second virtual machine according to an implementation.

FIG. 4 illustrates a timing diagram of cancelling a migration to a second virtual machine using an additional network interface according to an implementation.

FIG. 5 illustrates a computing system to manage the migration of one or more workloads from a first virtual machine to a second virtual machine according to an implementation.

### DETAILED DESCRIPTION

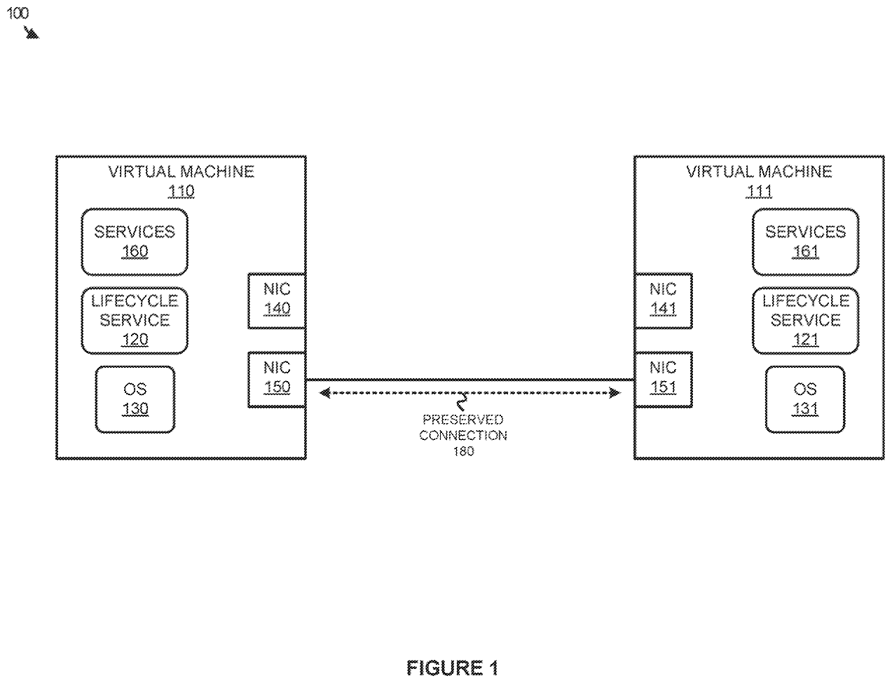

FIG. 1 illustrates a computing environment 100 to migrate from a first virtual machine to a second virtual machine according to an implementation. Computing environment 100 includes virtual machines 110-111, wherein virtual machines 110-111 includes lifecycle services 120-121, operating systems 130-131, services 160-161, and network interfaces (NICs) 140-141 and 150-152. Computing environment 100 further includes preserved connection 180 that is representative of a preserved connection between virtual machines to monitor a cancel of a migration between the virtual machines. Although demonstrated in the examples below using virtual machines, similar operations can be performed by container or some other virtualized endpoint.

In computing environment 100, virtual machine 110 is deployed on a host computing system to provide various operations for a tenant of computing environment 100. The operations may include database operations, data processing operations, front-end operations, or some other operations. During the execution of virtual machine 110, an administrator of computing environment 100 may generate a request to update services or utilities associated with virtual machine 110. These services may include networking services, resource usage services, database services, data processing services, or some other service, wherein the update may be used to provide enhanced performance or reliability in association with the virtual machine. To support the request, the one or more workloads supported by virtual machines will be migrated from the first virtual machine to a second virtual machine, wherein the second virtual machine may provide the updated services. In migrating the services, the services will be stopped on the first virtual machine and made available on the second virtual machine.

Here, virtual machine 111 is initiated to support the migration from virtual machine 110. Virtual machine 111 may operate on a separate host computing system, a separate data center, or some other location in relation to virtual machine 110. In some examples, virtual machine 111 may execute on the same host computing system as virtual machine 110. When the update is requested, lifecycle service 120 may identify configuration information associated with virtual machine 110, wherein the configuration information may include at least network interfaces for virtual machine 110. In at least one example, when the update is requested, lifecycle service 120 may generate a request to establish a temporary network interface that can be used to identify cancelation notifications from virtual machine 111. In computing environment 100, lifecycle service 120 will allocate network interface (NIC) 150 to communicate with virtual machine 111. Additionally, lifecycle service 120 may communicate with operating system 130 to identify IP addressing and other configuration information associated with the virtual machine.

Once the configuration information is identified, lifecycle service 120 can stop one or more services, including core and non-core services, and disable network interfaces for the virtual machine. Here, lifecycle service 120 may disable NIC 140, while maintaining NIC 150. In some implementations, NIC 150 may provide a communication interface capable of receiving Secure Shell (SSH) communications from virtual machine 111, wherein the SSH communications can be used to cancel the upgrade and the migration from the virtual machine 110 to virtual machine 111. In some examples, NIC 150 may be used to receive application programming interface (API) calls, HTTP requests, or some other communication capable of canceling the upgrade via the dedicated NIC. The cancelation may be caused by an administrator command at virtual machine 111, may be caused by a failure or error in starting one or more services in conjunction with the workload, may be caused by configuration failures, or may be caused by some other error. In response to identifying the error, which can be identified via lifecycle service 121, lifecycle service 121 may direct operating system 131 to use the temporary network with virtual machine 110 corresponding to preserved connection 180 and may communicate a cancel notification to virtual machine. In some implementations, virtual machine 110 may provide virtual machine 111 with one or more certificates or credentials that permit the virtual machine 111 to use SSH with virtual machine 110. Virtual machine 110 may also provide a passkey, a token, or some other authentication identifier to virtual machine 111 to permit virtual machine 111 to communicate with virtual machine 110. The cancel notification may be received by NIC 150 and identified by lifecycle service 120. Prior to communicating the cancel notification to virtual machine 110, lifecycle service 121 may disable the network interfaces or network configuration associated with the update, preventing virtual machine 111 from assuming the workload responsibilities associated with virtual machine 110. Accordingly, when the cancel notification is received by virtual machine 110, lifecycle service 120 may re-enable the networking interfaces separate from the network interface used in association with the communications for virtual machine 111. Specifically, lifecycle service 120 may enable NIC 140 to provide communications for the one or more services on virtual machine 110, wherein the one or more services

In some examples, lifecycle service 120 may initiate a second attempt at the migration and upgrade to for the virtual machine. In other examples, a notification may be generated for an administrator of computing environment 100 indicating the cancelation of the migration. In at least some implementations, virtual machine 110 may continue providing the platform for the one or more workloads after receiving the cancel notification from virtual machine 111.

Although demonstrated as performing the virtual machines, it should be understood that at least a portion of the lifecycle service may be deployed outside of the virtual machine. In some implementations, the lifecycle service, which can execute on the same host or another computing system, may identify the NICs on the host, including the dedicated NIC for cancellation, and initiate the operations to disable NICs and services.

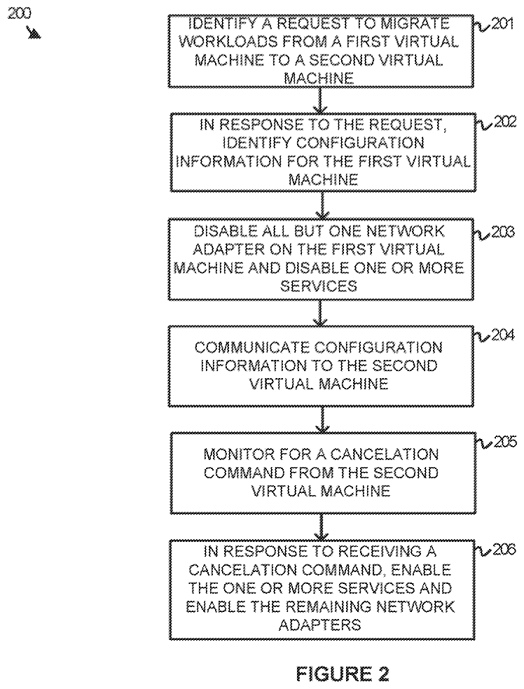

FIG. 2 illustrates an operation 200 of a virtual machine to manage a migration of workloads to a second virtual machine according to an implementation. The steps of operation 200 are referenced parenthetically in the paragraphs that follow with reference to systems and elements of computing environment 100 of FIG. 1.

For operation 200, a first virtual machine identifies or receives (201) a request to migrate one or more workloads from the first virtual machine to a second virtual machine. In response to the request, the first virtual machine identifies (202) configuration information for the first virtual machine, wherein the configuration information identifies a first network interface and one or more network interfaces for the first virtual machine. In computing environment 100, a request is generated to migrate one or more workloads from virtual machine 110 to virtual machine 111, wherein virtual machine 111 may provide an updated version of the virtual machine (or services supporting the workloads operating thereon). In response to the request, lifecycle service 120 may identify configuration information associated with virtual machine. In some implementations, at least a portion of the information may be provided by operating system 130. In other implementations, lifecycle service may maintain at least a portion of the information. Examples of the configuration information may include IP addressing information, network interface information, or some other information used by the virtual machine. In some examples, lifecycle service 120 may request a temporary network interface to communicate with the second virtual machine for the migration, wherein the temporary network interface may be used to communicate with and receive commands from the second virtual machine.

In addition to identifying the configuration information, operation 200 further disables (203) one or more additional network interfaces on the first virtual machine and one or more services on the first virtual machine. In at least one implementation, the one or more additional network interfaces may be used to support the workload of the virtual machine, while the remaining active network interface is used to support the handoff to virtual machine 111. Specifically, while NIC 140 is used to support the workload of virtual machine 110, NIC 150 is used to communicate configuration information with virtual machine 111 and monitor for a cancel notification provided by virtual machine 111. Once the one or more network interfaces and services are stopped on virtual machine 110, operation 200 communicates (204) at least a portion of the configuration information to the second virtual machine. The configuration information may include addressing and networking information (e.g., IP addresses, and network interfaces required), state information associated with the workload, or some other configuration information. The communication of the configuration information is implemented at least partially using the connection from NIC 150-151, wherein virtual machine 110 may be provided with the IP address for virtual machine 111 and NIC 151. In some implementations, as part of the configuration information, virtual machine 110 may provide a certificate or permissions that permit virtual machine 111 to communicate via an SSH session with virtual machine 110, wherein the SSH session may be used to communicate at least a cancelation notification from virtual machine 111 to virtual machine 110. In some examples, virtual machine 110 may provide passkeys, tokens, certificates, or some other authentication identifier to virtual machine 111 to permit virtual machine 111 to communicate or cancel the migration.

After the configuration information is communicated to the second virtual machine, the first virtual machine further monitors for the cancelation notification from the second virtual machine. In at least one implementation, lifecycle service 120 may monitor operating system 130 to determine whether a cancelation flag has been received from virtual machine 111 on NIC 150. Operation 200 identifies (205) a received cancel notification from the second virtual machine at the first network interface and, in response to the notification, enables (206) the one or more additional network interfaces. In some examples, in response to the notification, virtual machine 110 may further restart the one or more services that were stopped as part of initiating the migration to virtual machine 111 or may initiate a second attempt to migrate the workloads from virtual machine 110 to virtual machine 111 or some other virtual machine.

In some implementations, in identifying the cancelation of the migration to virtual machine 111, lifecycle service 121 may identify when one or more services are not initiated within a time window, when a service is unavailable, when a user requests that the migration be canceled, or some other cancelation event. In response to identifying the event, virtual machine 111 may stop one or more services executing on the virtual machine but keep the execution of lifecycle service 121. Lifecycle service 121 may use the temporary SSH connection to notify virtual machine 110 of the migration cancelation.

Although described in the previous example using a canceled migration from virtual machine 110 to virtual machine 111, the lifecycle services may manage migrations that succeed between virtual machines. For example, if the migration from virtual machine 110 to virtual machine 111 succeeded, virtual machine 111 may apply the network configuration supplied from virtual machine 111 and support the workloads that were previously provided by virtual machine 110. Once the network configuration is activated, which may include configuring one or more network interfaces for the virtual machine, virtual machine 111 may terminate the connection with virtual machine 110 and may further initiate an operation to shutdown virtual machine 110.

While demonstrated in the previous example with multiple NICs 141 and 151 at virtual machine 111, some examples may use a single NIC at virtual machine 111. The single NIC may be used to communicate with the dedicated NIC at virtual machine 110 to receive a cancel notification. Advantageously, a NIC is not required to be reserved on virtual machine 111 for the communications, but may use any available NIC to communicate a cancel notification to virtual machine 110.

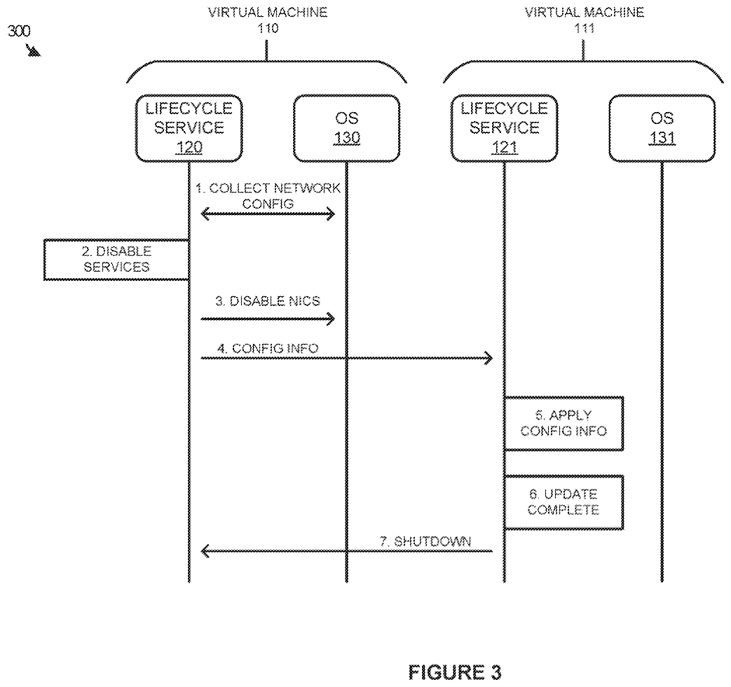

FIG. 3 illustrates a timing diagram 300 of providing an update by migrating workloads from a first virtual machine to a second virtual machine according to an implementation. Timing diagram 300 includes lifecycle services 120-121 and operating systems 130-131 of virtual machines 110-111. Timing diagram 300 is representative of a successful migration of one or more workloads between virtual machines.

As depicted, in response to a migration request that may include an upgrade request for virtual machine 110, lifecycle service 120 collects at least network configuration information from operating system 130 at step 1. The network configuration information may include IP address configurations associated with network interfaces on virtual machine 110, may comprise port information, or may comprise some other network information. Other configuration information identified by lifecycle service 120 may include certificate information, state information for the virtual machine, or some other information associated with the virtual machine. Once the network information is identified, lifecycle service 120 disables one or more services at step 2 and disables network interfaces other than a dedicated network interface to communicate with virtual machine 111 at step 3. Although demonstrated as occurring prior to disabling one or more network interfaces on virtual machine 110, disabling the services may occur at least partially after disabling the network interfaces. For example, non-core services, such as data processing services may be stopped prior to disabling the network interfaces, while core services, such as database services, may be stopped following the operation to disable the network interfaces.

In some implementations, virtual machine 110 may create a temporary network interface that can be used in the communication with virtual machine 111. This temporary network interface may include an IP address that permits virtual machine 111 to SSH to virtual machine 110 and provide an indication of a cancelation request. To support the SSH, virtual machine 110 may provide one or more certificates or other credentials that permit virtual machine 111 to communicate with virtual machine 110.

After the configuration information is identified and the one or more services and network interfaces are disabled, lifecycle service 120 communicates at least a portion of the configuration information to lifecycle service 121 on virtual machine 111 at step 4. The configuration information that is supplied may include one or more certificates, networking information, or some other configuration information. Lifecycle service 121 may then apply, at step 5, the configuration information from virtual machine 110 and complete the update associated with the migration at step 6. The update may provide improved performance, reliability, or some other update from virtual machine 110.

Once the update is completed, lifecycle service 121 may communicate with lifecycle service 120 to indicate the completion of the update and trigger the shutdown of virtual machine 110. In at least one implementation, the communication may use SSH, wherein credentials including at least one certificate are provided to virtual machine 111 to permit the SSH communications with virtual machine 110.

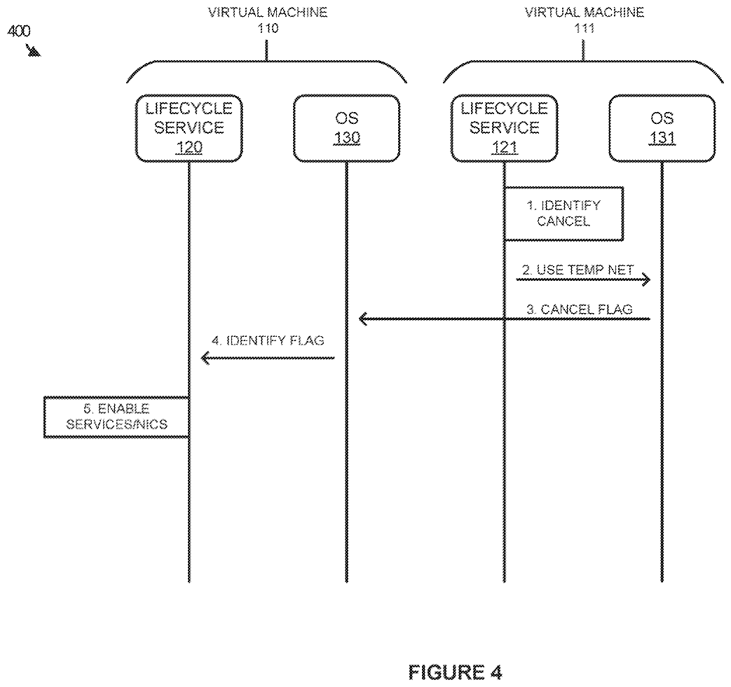

FIG. 4 illustrates a timing diagram 400 of cancelling a migration to a second virtual machine using an additional network interface according to an implementation. Timing diagram 400 includes lifecycle service 120-121 and operating systems 130-131 for virtual machines 110-111.

As described herein, when an update is requested for virtual machine 110, a second virtual machine may be initiated to support the migration of one or more workloads supported by virtual machine 110. The second virtual machine 111 may be used to provide additional functionality, additional reliability, or some other update in relation to virtual machine 110. To support the migration to virtual machine 111, lifecycle service 120 may identify configuration information including at least network information associated with virtual machine 110. In some implementations, lifecycle service 120 may further generate a temporary network interface that can be used to provide communications with virtual machine 111. In other implementations, virtual machine 110 may maintain a reserve network interface that can be used for migration communications with another virtual machine. Once the network interface is identified for communication with virtual machine 111, lifecycle service 120 may disable the remaining network interfaces and may stop or disable one or more services on virtual machine 110, wherein the services may include core services and non-core services. In some implementations, at least a portion of the services are stopped prior to disabling the one or more network interfaces. The temporary

After initiating the migration to virtual machine 111, lifecycle service 121 identifies a cancellation event for the migration at step 1. The cancellation event may occur due a request from a user to cancel the migration, may occur because of a failure of one or more services to be initiated on virtual machine 111, or may occur due to some other error in association with initiating a platform for the one or more workloads from virtual machine 110. In response to identifying the cancellation event, lifecycle service 121 may initiate, at step 2, the use of the temporary network connection established between virtual machine 111 and virtual machine 110 using the remaining network interface for virtual machine 110. Operating system 131 may then communicate a cancellation flag or notification to virtual machine 110 using the remaining active network interface of virtual machine 110.

In some implementations, virtual machine 110 may provide virtual machine 111 with one or more certificates that can be used to securely communicate with virtual machine 110. The certificates may include SSH certificates that permit virtual machine 111 to communicate with the network interface designated for the secure communications on virtual machine 110. In some examples, rather than certificates, the virtual machines may exchange passwords, tokens, or some other information that permits the virtual machine 111 to communicate with virtual machine 110. Lifecycle service 120 may identify the receipt of the cancel notification at operating system 130 at step 4 and enable the one or more network interfaces on virtual machine 110 and, in some examples, enable the one or more services on virtual machine 110 at step 5.

In some implementations, when the migration is initiated from virtual machine 110 to virtual machine 111, virtual machine 111 may assume the networking identity associated with virtual machine 110. To assume the networking identity, lifecycle service 120 disables one or more network interfaces on virtual machine 110 associated with the networking identity and uses an initiated network interface or reserved network interface to communicate with virtual machine 111. Once stopped, the networking information may be provided to virtual machine 111 and applied as network interfaces on virtual machine 111. For example, a first network interface on virtual machine 110 may be used for one or more workloads on the virtual machine. When the migration is required as part of an update, a temporary or reserved network interface may be assigned to communicate with virtual machine 111. The temporary or reserved network interface is associated with a first IP address, while the first network interface is associated with a second IP address. Once the network configuration information is identified for the network interfaces, lifecycle service 120 may disable the first network interface, leaving the temporary or reserved network interface available to communicate with virtual machine 111. Virtual machine 111 is then provided with networking configuration information that permits virtual machine 111 to operate in place of virtual machine 110. Thus, virtual machine 111 may initiate a network interface that corresponds or acts in place of the first network interface from virtual machine 110.

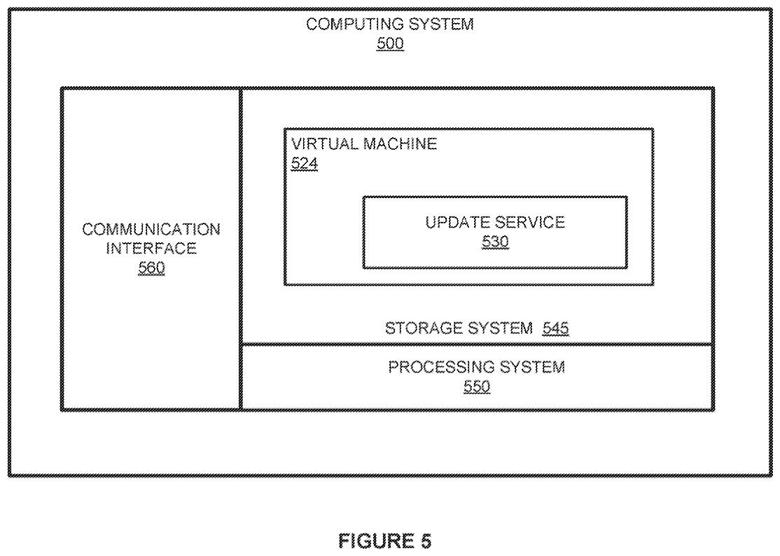

FIG. 5 illustrates a computing system 500 to manage the migration of one or more workloads from a first virtual machine to a second virtual machine according to an implementation. Computing system 500 is representative of any computing system or systems with which the various operational architectures, processes, scenarios, and sequences disclosed herein for a host computing system for virtual machines can be implemented. Computing system 500 is an example of a host computing system capable of acting as a host of at least one virtual machine of virtual machines 110-111 of FIG. 1, although other examples may exist. Computing system 500 includes storage system 545, processing system 550, and communication interface 560. Processing system 550 is operatively linked to communication interface 560 and storage system 545. Communication interface 560 may be communicatively linked to storage system 545 in some implementations. Computing system 500 may further include other components such as a battery and enclosure that are not shown for clarity.

Communication interface 560 comprises components that communicate over communication links, such as network cards, ports, radio frequency (RF), processing circuitry and software, or some other communication devices. Communication interface 560 may be configured to communicate over metallic, wireless, or optical links. Communication interface 560 may be configured to use Time Division Multiplex (TDM), Internet Protocol (IP), Ethernet, optical networking, wireless protocols, communication signaling, or some other communication format—including combinations thereof. Communication interface 560 may be configured to communicate with one or more other computing systems, wherein the other computing systems may comprise host computing systems, desktop computers, laptop computers, or some other computing system.

Processing system 550 comprises microprocessor and other circuitry that retrieves and executes operating software from storage system 545. Storage system 545 may include volatile and nonvolatile, removable, and non-removable media implemented in any method or technology for storage of information, such as computer readable instructions, data structures, program modules, or other data. Storage system 545 may be implemented as a single storage device but may also be implemented across multiple storage devices or sub-systems. Storage system 545 may comprise additional elements, such as a controller to read operating software from the storage systems. Examples of storage media include random access memory, read only memory, magnetic disks, optical disks, and flash memory, as well as any combination or variation thereof, or any other type of storage media. In some implementations, the storage media may be a non-transitory storage media. In some instances, at least a portion of the storage media may be transitory. In no case is the storage media a propagated signal.

Processing system 550 is typically mounted on a circuit board that may also hold the storage system. The operating software of storage system 545 comprises computer programs, firmware, or some other form of machine-readable program instructions. The operating software of storage system 545 comprises virtual machine 524 with update service 530. The operating software on storage system 545 may further include an operating system, utilities, drivers, network interfaces, applications, or some other type of software. When read and executed by processing system 550 the operating software on storage system 545 directs computing system 500 to operate as described herein. In at least one example, the operating software can provide at least operation 200 described above in FIG. 2.

In at least one implementation, update service 530 directs processing system 550 to receive a request to migrate one or more workloads from virtual machine 524 to a second virtual machine, wherein the second virtual machine may execute on a different computing system or may execute on the same computing system. In response to the request, update service 530 directs processing system 550 to identify configuration information for the first virtual machine, wherein the configuration information identifies a first network interface for virtual machine 524 and one or more additional network interfaces for virtual machine 524. In at least one implementation, the first network interface may comprise a standby or reserved network interface that is used to communicate with at least the second virtual machine to support the migration of the one or more workloads. In another implementation, update service 530 may request a temporary network interface that is applied to the virtual machine to support the migration to the second virtual machine. The reserved or initiated network interface may be allocated an IP address that is not used during the operation of virtual machine 524 to support the workloads. For example, the one or more additional network interfaces may include IP addresses that are used in association with the workloads on the virtual machine, while the first network interface comprises an IP address that is used for the communication with the second virtual machine. In at least one implementation, at least some of the configuration information is obtained using the operating system of virtual machine 110.

Once the configuration information is identified, update service further disables one or more services on virtual machine 524 and disables the one or more additional network interfaces of virtual machine 524. In some implementations, at least a portion of the services may be disabled prior to disabling the network interfaces. For example, non-core services may be disabled prior to disabling the one or more additional network interfaces, while the core services associated with the virtual machine can be disabled after the network interfaces. As an example, virtual machine 524 may use a first network interface to provide the workload operations associated with the virtual machine and may initiate a second network interface to support communications with the second virtual machine. Update service 530 may stop the execution of non-core services (e.g., services providing a database, data processing, and the like) and disable the first network interface. Once disabled, update service may disable remaining core services of virtual machine 524.

In addition to disabling the one or more additional network interfaces and the disabling or stopping the one or more services, update service 530 further directs processing system 550 to communicate at least a portion of the configuration information to the second virtual machine. The portion communicated may include communication configuration information, certificates to support SSH communications from the second virtual machine to virtual machine 524, or some other configuration information. The information may be used by the second virtual machine to support the workloads or act in place of virtual machine 524 using the addressing information for virtual machine 524.

In some implementations, when the update is successful at the second virtual machine, the second virtual machine may communicate a notification to the first virtual machine indicating the success. In response to the notification, the communication between the virtual machines can be terminated and, in some examples, virtual machine 524 may be powered down.

In some implementations, the update using the migration to the second virtual machine may fail or be canceled by the second virtual machine. The cancelation may occur because of a failure to initiate one or more services, a request from a user indicating the cancelation of the migration, a failure to initiate one or more of the network interfaces, or some other cancelation event. In response to identifying a cancelation event, the second virtual machine may use one or more certificates provided by virtual machine 524 to communicate, via SSH, with virtual machine 524. The communication may include a cancel notification or flag, wherein update service 530 may direct processing system 550 to identify the notification and, in response to identifying the notification, enable the one or more additional network interfaces that were disabled as part of the migration. In some implementations, update service 530 may further initiate the one or more services that were stopped as part of the migration. Prior to communicating the cancel notification, the second virtual machine may also disable any of the network interfaces that were initiated as part of the migration and stop one or more services that were initiated as part of the migration.

Although demonstrated as migrating one or more workloads from virtual machine 524 to a second virtual machine, virtual machine 524 may represent the second virtual machine, wherein a virtual machine on another host computing system may initiate a migration to the second virtual machine. In at least one implementation, virtual machine 524 may be initiated to act in place of the virtual machine on another host computing system, wherein virtual machine 524 may comprise a replicated version of the virtual machine on the other host computing system. Update service 530 may be used to allocate addressing to the virtual machine 524 from the other virtual machine and initiate one or more services on virtual machine 524. When a cancelation event occurs for the update, update service 530 may revert the networking to the temporary connection with the other virtual machine (i.e., the network interface reserved for the communication with the other virtual machine) and communicate a cancel notification to the other virtual machine. In reverting to the network connection, update service 530 may disable the one or more other network interfaces (interfaces associated with the workload), permitting the other virtual machine to assume the addressing and network interfaces after the cancel notification is received from virtual machine 524.

The included descriptions and figures depict specific implementations to teach those skilled in the art how to make and use the best mode. For teaching inventive principles, some conventional aspects have been simplified or omitted. Those skilled in the art will appreciate variations from these implementations that fall within the scope of the invention. Those skilled in the art will also appreciate that the features described above can be combined in various ways to form multiple implementations. As a result, the invention is not limited to the specific implementations described above, but only by the claims and their equivalents.

What is claimed is:

1. A method comprising:
in a first virtual machine on a first computing system, receiving a request to migrate one or more workloads from the first virtual machine to a second virtual machine;
in the first virtual machine and in response to the request, identifying configuration information for the first virtual machine, wherein the configuration information identifies a first network interface and one or more additional network interfaces;
in the first virtual machine, disabling one or more services;
in the first virtual machine, disabling the one or more additional network interfaces;
in the first virtual machine, communicating at least a portion of the configuration information to the second virtual machine;
in the first virtual machine, receiving a cancel notification from the second virtual machine at the first network interface; and
in the first virtual machine and in response to the cancel notification, enabling the one or more additional network interfaces.

2. The method of claim 1 further comprising:
in the first virtual machine and in response to the cancel notification, enabling the one or more services.

3. The method of claim 1, wherein the one or more services comprise at least a database service.

4. The method of claim 1 further comprising, in the first virtual machine, adding the first network interface to the first virtual machine in response to the request.

5. The method of claim 1 further comprising:
in the second virtual machine, identifying a cancel triggering event; and
in the second virtual machine and in response to the cancel triggering event, communicating the cancel notification to the first virtual machine.

6. The method of clam 5, wherein the cancel triggering event comprises a failure to initiate one or more services on the second virtual machine.

7. The method of claim 1, wherein receiving the cancel notification from the second virtual machine at the first network interface comprises receiving the cancel notification at the first network interface using Secure Shell (SSH) or an application programming interface (API) command.

8. The method of claim 1, wherein communicating at least the portion of the configuration information to the second virtual machine comprises communicating at least one authentication identifier to the second virtual machine, wherein the at least one authentication identifier permits the second virtual machine to communicate the cancel notification to the first virtual machine.

9. A system comprising:
a first computing system executing a first virtual machine;
a second computing system executing a second virtual machine and configured to:
receive a request to migrate one or more workloads from the second virtual machine to the first virtual machine;
identify configuration information for the second virtual machine, wherein the configuration information identifies a first network interface and one or more additional network interfaces on the second virtual machine;
disable one or more services executing on the second virtual machine;
disable the one or more additional network interfaces;
communicate at least a portion of the configuration information to the first virtual machine;
receive a cancel notification from the first virtual machine at the first network interface; and
in response to the cancel notification, enable the one or more additional network interfaces on the second virtual machine.

10. The system of claim 9, wherein the second computing system is further configured to, in response to the cancel notification, enable the one or more services on the second virtual machine.

11. The system of claim 9, wherein the one or more services comprise at least a database service.

12. The system of claim 9, wherein the second computing system is further configured to add the first network interface to the second virtual machine in response to the request.

13. The system of claim 9, wherein the first computing system is further configured to:
identify a cancel triggering event for the second virtual machine; and
in response to identifying the cancel triggering event, communicate the cancel notification from the first virtual machine to the second virtual machine.

14. The system of claim 13, wherein the cancel triggering event comprises a failure to initiate one or more services on the second virtual machine.

15. The system of claim 9, wherein receiving the cancel notification from the second virtual machine at the first network interface comprises receiving the cancel notification at the first network interface using Secure Shell (SSH) or an application programming interface (API) command.

16. The system of claim 15, wherein communicating at least the portion of the configuration information to the second virtual machine comprises communicating at least one authentication identifier to the second virtual machine, wherein the at least one authentication identifier permits the second virtual machine to communicate the cancel notification to the first virtual machine.

17. A computing apparatus comprising:
a storage system;
a processing system operatively coupled to the storage system; and
program instructions stored on the storage system that, when executed by the processing system, direct the computing apparatus to:
receive a request to migrate one or more workloads from a first virtual machine to a second virtual machine;
identify configuration information for the first virtual machine, wherein the configuration information identifies a first network interface and one or more additional network interfaces for the first virtual machine;
disable one or more services executing on the first virtual machine;
disable the one or more additional network interfaces;
communicate at least a portion of the configuration information to the second virtual machine;
receive a cancel notification from the second virtual machine at the first network interface; and
in response to the cancel notification, enable the one or more additional network interfaces on the first virtual machine.

18. The computing apparatus of claim 17, wherein the program instructions further direct the computing apparatus to, in response to the cancel notification, enable the one or more services on the second virtual machine.

19. The computing apparatus of claim 17, wherein receiving the cancel notification from the second virtual machine at the first network interface comprises receiving the cancel notification at the first network interface using Secure Shell (SSH).

20. The computing apparatus of claim 17, wherein communicating at least the portion of the configuration information to the second virtual machine comprises communicating at least one certificate to the second virtual machine, wherein the at least one certificate permits the second virtual machine to SSH with the first virtual machine.
